(19) United States
(12) Patent Application Publication
(10) Pub. No.: US 2010/0053680 A1
(43) Pub. Date: Mar. 4, 2010

(54) PRINTING SYSTEM, CONTROL METHOD, AND STORAGE MEDIUM

(75) Inventor: Masayuki Sato, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/549,853

(22) Filed: Aug. 28, 2009

(30) Foreign Application Priority Data
Aug. 29, 2008 (JP) 2008-221789

(51) Int. Cl. G06F 15/00

(52) U.S. Cl. 358/1.15

(57) ABSTRACT

A printing system that conveys sheets printed by a printing unit to a sheet processing unit connected to the printing unit and causes the sheet processing unit to perform post processing on the sheet. When an inline job is temporarily stopped in which sheets printed by the printing unit are conveyed to the post-processing unit, and post processing is caused to be executed on the sheets by the post-processing unit, if an offline job is executable in which sheets are fed from a predetermined sheet feed section without executing printing by the printing unit, and post processing is caused to be executed on the sheets by the post-processing unit, the offline job is permitted to be executed.

### BACKGROUND OF THE INVENTION

1. Field of the Invention

The present invention relates to a printing system, a control method, and a storage medium storing a program for causing a computer to execute the control method, which enable a post-processing unit connected to a printing unit to execute only post processing without involving printing by the printing unit.

2. Description of the Related Art

Recently, a POD (Print On Demand) printing system using an electrophotographic printing apparatus or an inkjet printing apparatus has been proposed so as to outdo the conventional printing industry (see e.g. US Published Application No. 20040190057). The POD printing system of this type makes it possible to dispense with an operation for preparing a final copy for printing and other complicated operations.

However, there is still a lot to be studied before such a POD printing system is made commercially available i.e. put into practical use. For example, the conventional printing systems are not configured such that post processing by an inline finisher connected to a printer (i.e. a finisher having a sheet path connected to the printer) can be used without involving printing by the printer.

From the above viewpoint, a technique should be proposed while considering beforehand a possibility that it will be demanded in the future to use only post processing by a post-processing unit connected to a printing unit without involving printing by the printing unit. However, since such a demand is not strong in actuality, no effective proposal has ever been seen.

Further, during printing by the printing system, it sometimes occurs that the printing is temporarily stopped due to some cause (maintenance of the printer, running out of toner, paper jam, etc.). During the stop of the printing, the printing system cannot operate, which causes lowering of the productivity of the printing system.

### SUMMARY OF THE INVENTION

In a first aspect of the present invention, there is provided a printing system that conveys sheets printed by a printing unit to a sheet processing unit connected to the printing unit and causes the sheet processing unit to perform post processing on the sheet, comprising an execution unit configured to execute either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed on the sheets by the post-processing unit, and a control unit configured to permit execution of an executable offline job when the inline job being executed by the execution unit is temporarily stopped.

In a second aspect of the present invention, there is provided a method of controlling a printing system that conveys sheets printed by a printing unit to a sheet processing unit connected to the printing unit and causes the sheet processing unit to perform post processing on the sheet, comprising executing either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed on the sheets by the post-processing unit, and permitting execution of an executable offline job when the inline job being executed is temporarily stopped.

In a third aspect of the present invention, there is provided a computer-readable storage medium storing a program for causing a computer to execute a method of controlling a printing system that conveys sheets printed by a printing unit to a sheet processing unit connected to the printing unit and causes the sheet processing unit to perform post processing on the sheet, wherein the program comprises a code to execute either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed on the sheets by the post-processing unit, and a code to permit execution of an executable offline job when the inline job being executed is temporarily stopped.

According to the present invention, post processing by the post-processing unit connected to the printing unit can be used without involving printing by the printing unit. This makes it possible to execute only post processing that can be executed by the post-processing unit in a manner separate from a printing job. Therefore, it is possible to improve the productivity of the post-processing unit connected to the printing unit. Further, according to the present invention, when the printing job is stopped due to a cause which does not hinder execution of post processing, it is possible to execute the post processing by the post-processing unit. This makes it possible to flexibly execute the post processing instructed by the user, to thereby improve productivity.

The features and advantages of the invention will become more apparent from the following detailed description taken in conjunction with the accompanying drawings.

### BRIEF DESCRIPTION OF THE DRAWINGS

FIG. 1 is a diagram useful in explaining an overall POD system.

FIG. 2 is a diagram useful in explaining the internal configuration of a printing system.

FIG. 3 is a view useful in explaining the configuration of the printing system.

FIG. 4 is a view showing the internal construction of a glue binding machine.

FIG. 5 is a view of an example of an operating section.

FIG. 6 is a diagram showing an example of a configuration screen for selecting a type of sheet processing.

FIG. 7 is a diagram showing an example of a configuration screen for selecting a type of sheet processing (only sheet processing).

FIG. 8 is a diagram showing an example of a configuration screen displayed when print processing (an inline job) is being executed.

FIG. 9 is a diagram showing an example of a configuration screen displayed when print processing is temporarily stopped (both inline and offline jobs are unexecutable).

FIG. 10 is a diagram showing an example of a configuration screen displayed when print processing is temporarily stopped (offline jobs are executable).

FIG. 11 is a diagram showing an example of a configuration screen displayed when sheet processing (an offline job) is being executed.

FIG. 12 is a diagram-showing an example of a configuration screen displayed when sheet processing (an offline job) is being executed for enabling a user to perform selection from a displayed list of printing functions that can be set from the printing apparatus.

FIG. 13 is a diagram showing an example of a configuration screen displayed for enabling a user to perform selection from a list of documents stored in the HDD of the printing apparatus, in a state permitting execution of printing.

FIG. 14 is a flowchart of a control process executed when print processing by the printing system is temporarily stopped, for causing sheet processing to be executed.

### DETAILED DESCRIPTION OF THE EMBODIMENTS

The present invention will now be described in detail below with reference to the accompanying drawings showing embodiments thereof. However, description of the following embodiments is given only by way of example, and it is to be construed that examples disclosed therein are to be modified as required according to the configuration of an apparatus to which the present invention is applied, and other various conditions, but the present invention is by no means limited to them.

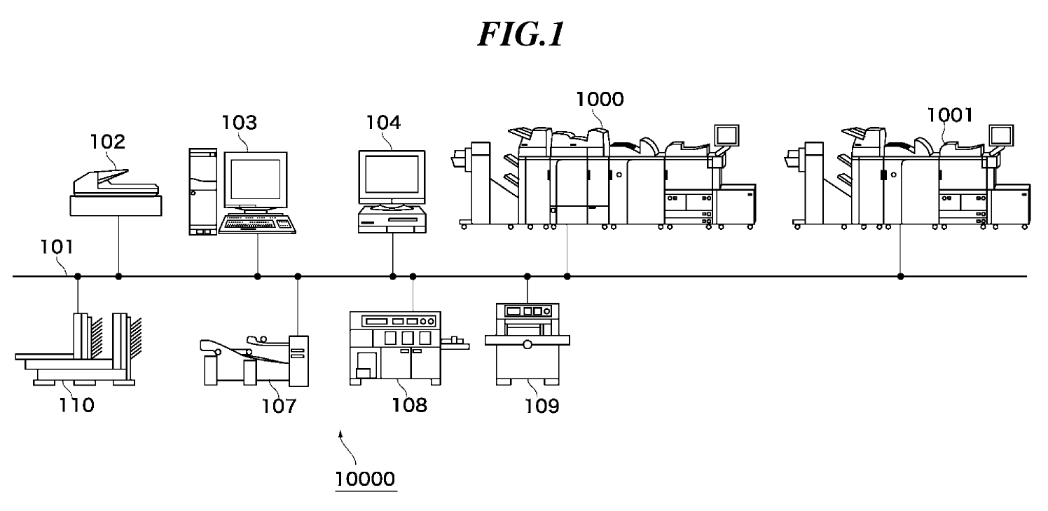

A POD system 10000 shown in FIG. 1 includes printing systems 1000 and 1001, a scanner 102, a server computer 103 (hereinafter referred to as “the PC 103”), and a client computer 104 (hereinafter referred to as “the PC 104”), which are interconnected via a network 101. Further, the POD system 10000 includes a sheet folding machine 107, a cutting machine 109, a saddle stitching machine 110, and a case binding machine 108.

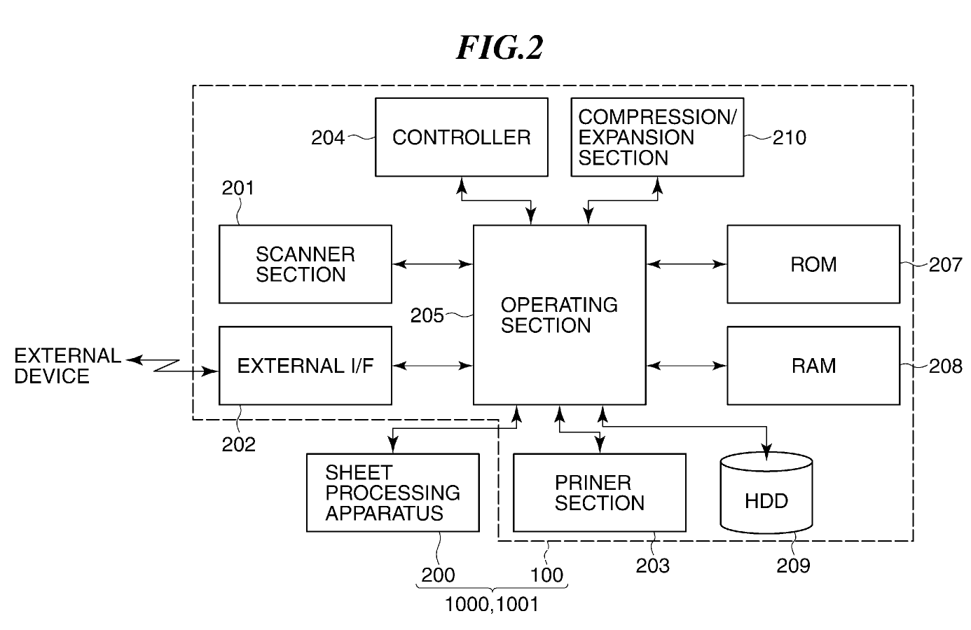

Referring to FIG. 2, each of the printing system 1000 and 1001 is comprised of a printing apparatus 100 and a sheet processing apparatus 200. In the present embodiment, the printing apparatus 100 will be described based on an example in which it is implemented by an MFP (Multi-Function Peripheral) equipped with a plurality of functions including a copying function and a printing function. However, the printing apparatus 100 may be a single-function printing apparatus having only the copying function or the printing function.

The PC 103 manages transmission and reception of data to and from various apparatuses connected to the network 101. The PC 104 transmits image data to the printing apparatus 100 or the PC 103 via the network 101. The sheet folding machine 107 performs folding of sheets printed by the printing apparatus 100. The case binding machine 108 performs case binding of sheets printed by the printing apparatus 100. The cutting machine 109 performs cutting of each sheet bundle formed by sheets printed by the printing apparatus 100. The saddle stitching machine 110 performs saddle-stitch processing on each sheet bundle formed by sheets printed by the printing apparatus 100.

In the case of using the sheet folding machine 107, the case binding machine 108, the cutting machine 109, or the saddle stitching machine 110, a user takes out a bundle of printed sheets from the printing system 1000 or 1001 and sets the same in the machine so as to cause the machine to perform its processing. The machines and apparatuses included in the POD system 10000 in FIG. 1 except the saddle stitching machine 110 are connected to the network 101 such that they can perform data communication with each other.

Although in the present embodiment, the printing system 1001 has the same mechanism as that of the printing system 1000, this is not limitative. Further, the functions of the present embodiment can be realized if only either of the printing systems exists. In the present embodiment, it is assumed that the printing system 1000 is provided with various functions described below.

Next, the configuration of the printing system 1000 will be described with reference to the FIG. 2 system block diagram.

Various units or components included in the printing system 1000 shown in FIG. 2 belong to the printing apparatus 100 except the sheet processing apparatuses 200. The printing apparatus 100 can have a desired number of sheet processing apparatuses 200 connected thereto.

The printing system 1000 (1001) is configured to be capable of causing the sheet processing apparatuses 200 connected to the printing apparatus 100 to execute sheet processing on sheets printed by the printing apparatus 100. It should be noted that it is possible to form the printing system 1000 by the printing apparatus 100 alone without connecting the sheet processing apparatuses 200 to the printing apparatus 100.

Each of the sheet processing apparatuses 200 is communicable with the printing apparatus 100, and is capable of performing sheet processing, i.e. post processing, described hereinafter, in response to an instruction from the printing apparatus 100. A scanner section 201 reads an image from an original and converts the image into image data, followed by transferring the image data to another unit. An external interface (I/F) 202 exchanges data with other apparatuses connected to the network 101. A printer section 203 prints an image on a sheet based on input image data. An operating section 204 has a hard key input section (key input section) 402 and a touch panel section 401, described hereinafter with reference to FIG. 5, and receives instructions from the user via the hard key input section 402 or the touch panel section 401. Further, the operating section 204 performs various kinds of display on the touch panel section 401.

A controller 205 performs centralized overall control of the processing and operations of the respective units included in the printing system 1000 or 1001. More specifically, the controller 205 controls not only the operation of the printing apparatus 100, but also that of each of the sheet processing apparatuses 200 connected to the printing apparatus 100. A ROM 207 stores various computer programs to be executed by the controller 205. For example, the ROM 207 stores programs for causing the controller 205 to execute processes of respective flowcharts, described hereinafter, and a display control program required for displaying various kinds of configuration screens, described hereinafter. Further, the ROM 207 stores a program for causing the controller 205 to perform an operation for interpreting PDL (Page Description Language) code data received from the PC 103, the PC 104, or the like, and converting the data into raster image data. Furthermore, the ROM 207 stores a boot sequence program, font information, etc.

A RAM 208 stores image data sent from the scanner section 201 or the external interface (I/F) 202, various kinds of programs loaded from the ROM 207, and configuration information. Further, the RAM 208 stores information concerning the sheet processing apparatuses 200 (including the number (0 to n) of the apparatuses connected to the printing apparatus 100, information concerning the functions of each of the sheet processing apparatuses 200, the connection order of the sheet processing apparatuses 200, and so forth).

A HDD (hard disk drive) 209 includes a hard disk and a drive section that reads/writes data from/into the hard disk. The HDD 209 is a large-capacity storage device for storing image data that is input from the scanner section 201 or the external interface 202 and is compressed by a compression/expansion section 210. The controller 205 is capable of causing the printer section 203 to print image data stored in the HDD 209, based on instructions from the user.

Further, the controller 205 is capable of sending image data stored in the HDD 209 to an external device, such as the PC 103, via the external interface 202 based on instructions from the user. Similarly, the controller 205 is capable of receiving image data from an external device, such as the PC 103, via the external interface 202. Furthermore, the controller 205 is capable of searching an external device connected to the network 101, via the external interface 202.

The compression/expansion section 210 compresses/expands image data and the like stored in the RAM 208 or the HDD 209 using one of various kinds of compression methods including JBIG and JPEG.

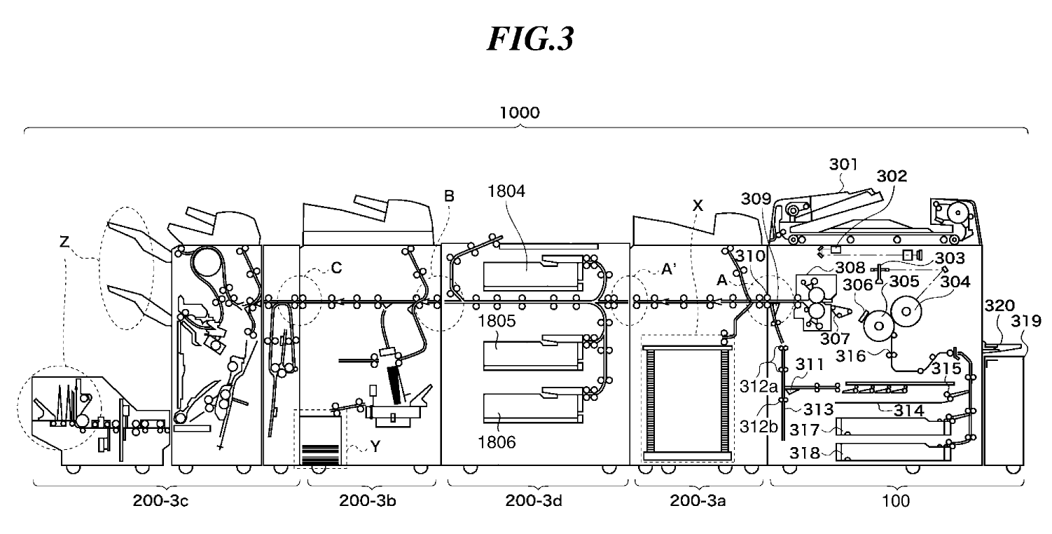

Next, the configuration of the printing system 1000 will be described with reference to FIG. 3. FIG. 3 is a cross-sectional view of the printing apparatus 100 and the sheet processing apparatus 200 connected to the printing apparatus 100.

An automatic document feeder (ADF) 301 sequentially separates sheets of an original bundle set on the sheet stacking surface of a document tray, one by one in order from a first page, and conveys the separated sheets one by one onto an original platen glass for scanning by the scanner section 302. The scanner section 302 reads an image from an original conveyed onto the original platen glass and converts the image into image data by a CCD (Charge Coupled Device). A rotary polygon mirror 303 receives light, such as a laser beam, modulated according to the image data, and emits the light onto a photosensitive drum 304 via a reflective mirror as reflected scanning light. A latent image formed on the photosensitive drum 304 by the laser beam is developed by toner, and the developed toner image is transferred onto a sheet fed via a registration roller 316 and wrapped around a transfer drum 305.

This sequential image forming process is carried out sequentially using yellow (Y) toner, magenta (M) toner, cyan (C) toner, and black (K) toner in the mentioned order, whereby a full-color image is formed. After execution of the four image forming processes, the sheet having the full-color image formed thereon is separated from the transfer drum 305 by a separation claw 306, and is conveyed to a fixing device 308 by a pre-fixing conveyor 307.

The fixing device 308 is formed by rollers and a belt. The fixing device 308 incorporates a heater, such as a halogen heater, and dissolves toner of the toner image transferred on the sheet, by heat and pressure, to thereby fix the toner image on the sheet. A discharge flapper 309 is configured to be swingable about a swing shaft to regulate a sheet conveying direction. When the discharge flapper 309 has swung in a clockwise direction as viewed in FIG. 3, a sheet is conveyed straight to be discharged out of the apparatus by a discharge roller pair 310. The controller 205 controls the printing apparatus 100 to execute the above-mentioned series of sequences to thereby perform single-sided printing.

On the other hand, in the case of forming images on the respective opposite sides of a sheet, the discharge flapper 309 swings in a counterclockwise direction as viewed in FIG. 3, to change a sheet conveying direction downward, whereby a sheet is conveyed into a double-sided-printing conveyor. The double-sided-printing conveyor is comprised of an inversion flapper 311, inversion rollers 312a and 312b, an inversion guide 313, and a double-sided tray 314. The inversion flapper 311 swings about a swing shaft to regulate a sheet conveying direction.

In the case of processing a double-sided printing job, the controller 205 swings the inversion flapper 311 in the counterclockwise direction as viewed in FIG. 3 to thereby convey a sheet having an image formed on a first side thereof in the printer section 203 to the inversion guide 313 via the inversion rollers 312a. Then, the controller 205 temporarily stops the inversion rollers 312b in a state nipping the trailing end of the sheet, and then causes the inversion flapper 311 to swing in the clockwise direction as viewed in FIG. 3. Subsequently, the controller 205 causes the inversion rollers 312b to perform reverse rotation. Thus, the controller 205 causes the sheet to be conveyed in a switched-back manner, whereby the sheet is guided onto the double-sided tray 314 with its leading and trailing ends reversed.

The sheet guided into the double-sided tray 314 is temporarily placed thereon, and is then conveyed to the registration roller 316 again by refeed rollers 315. At this time, the sheet is conveyed with a reverse side thereof opposite to the first side in a facing relation to the photosensitive drum 304. Then, a second-side image is formed on the second side (reverse side) of the sheet by processes similar to those for the first side. The sheet having the images formed on the both sides thereof goes through the fixing process by the fixing device 308, and is discharged out of the printing apparatus 100 via the discharge roller pair 310. The controller 205 controls the printing apparatus 100 to execute the above-mentioned series of sequences to thereby perform double-sided printing.

The printing apparatus 100 has feeder sections each containing sheets necessary for printing. The feeder sections include sheet feed cassettes 317 and 318 (each of which is capable of containing e.g. 500 sheets), a sheet feed deck 319 (which is capable of containing e.g. 5000 sheets), and a manual feed tray 320. The sheet feed cassettes 317 and 318 and the sheet feed deck 319 are configured such that sheets of types different in size and material can be separately set in the respective feeder sections. It is possible to set various types of sheets including special sheets, such as OHP sheets, on the manual feed tray 320. Each of the sheet feed cassettes 317 and 318, the sheet feed deck 319, and the manual feed tray 320 is provided with a feed roller, and sheets therein are continuously fed one by one by the feed roller.

Next, a description will be given of the sheet processing apparatuses 200 appearing in FIG. 3.

The sheet processing apparatuses 200 included in the printing system 1000 according to the present embodiment can be selected as desired from various kinds of sheet processing apparatuses to connect a desired number of them to one another insofar as sheets can be sequentially conveyed from an upstream apparatus to a downstream one through a sheet conveying path. For example, as shown in FIG. 3, a large-capacity stacker 200-3a, an inserter 200-3d, a glue binding machine 200-3b, and a saddle stitching machine 200-3c can be sequentially connected to one another in the mentioned order as viewed from the printing apparatus 100, and can be selectively used in the printing system 1000. Further, each of the sheet processing apparatuses 200 has a sheet discharging section, so that the user can take out sheets having undergone sheet processing from the sheet discharging section.

The controller 205 of the printing apparatus 100 receives a request for execution of sheet processing of a type selected by the user from candidates of various types of sheet processing executable by the sheet processing apparatuses 200 connected to the printing apparatus 100, via the operating section 204, together with a printing execution request. Then, in response to the printing execution request of the job received from the user via the operating section 204, the controller 205 causes the printer section 203 to execute print processing required for the job. Further, the controller 205 causes sheets having undergone the print processing to be conveyed through the sheet conveying path to a sheet processing apparatus which is capable of executing the sheet processing desired by the user, and causes the sheet processing apparatus to execute the sheet processing.

Let it be assumed that the printing system 1000 having a system configuration shown in FIG. 3 receives a job associated with a printing execution request from the user and that the user has designated execution of large-quantity stack processing by the large-capacity stacker 200-3a. This job is hereafter referred to as “the stacker job”.

In the case of processing the stacker job in the printing system 1000 shown in FIG. 3, the controller 205 causes the printing apparatus 100 to convey sheets printed by the printing apparatus 100 into the large-capacity stacker 200-3a via a point A appearing in FIG. 3. Thereafter, the controller 205 causes the large-capacity stacker 200-3a to execute stack processing of the stacker job. Then, the controller 205 holds a printout (one set of the printed sheets) subjected to the stack processing by the large-capacity stacker 200-3a in a discharge destination X within the large-capacity stacker 200-3a, without conveying the printout to another apparatus (e.g. an apparatus disposed downstream of the printing apparatus 100).

The printout held in the discharge destination X for the stacker job can be taken out directly from the discharge destination X by the user. This eliminates the necessity of a series of apparatus operations and a user operation for conveying sheets to a discharge destination Z most downstream in the sheet conveying direction in FIG. 3 and then taking out the printout for the stacker job.

Let it be assumed that the printing system 1000 having the system configuration shown in FIG. 3 receives a job associated with a printing execution request from the user and that the user has designated execution of sheet processing (e.g. glue binding, i.e. either case binding or top gluing) by the glue binding machine 200-3b. This job is hereafter referred to as “the glue binding job”.

In the case of processing the glue binding job by the system configured as shown in FIG. 3, the controller 205 causes the printing system 1000 to convey sheets printed by the printing apparatus 100 into the glue binding machine 200-3b via the point A, a point A′, and a point B appearing in FIG. 3. Thereafter, the controller 205 causes the glue binding machine 200-3b to execute glue binding of the glue binding job. Then, the controller 205 holds the printout subjected to the glue binding by the glue binding machine 200-3b in a discharge destination Y within the glue binding machine 200-3b, without conveying the printout to another apparatus (e.g. an apparatus disposed downstream of the printing apparatus 100).

Further, let it be assumed that the printing system 1000 having the system configuration shown in FIG. 3 receives a job associated with a printing execution request from the user and that the user has designated execution of sheet processing by the saddle stitching machine 200-3c. Examples of sheet processing executed by the saddle stitching machine 200-3c include saddle-stitch processing, stapling, punching, cutting, shift discharging, and folding. In the present embodiment, the job associated with sheet processing by the saddle stitching machine 200-3c is hereafter referred to as “the saddle-stitch job”.

In the case of processing the saddle-stitch job by the system configured as shown in FIG. 3, the controller 205 causes the printing system 1000 to convey sheets printed by the printing apparatus 100 into the saddle stitching machine 200-3c via the points A and A′, the point B, and a point C. Thereafter, the controller 205 causes the saddle stitching machine 200-3c to execute the sheet processing of the saddle-stitch job. Then, the controller 205 holds the printout subjected to the sheet processing by the saddle stitching machine 200-3c in the discharge destination Z within the saddle stitching machine 200-3c.

It should be noted that the discharge destination Z is a selected one of a plurality of candidates for selection as the discharge destination Z. This is because the saddle stitching machine 200-3c is capable of executing a plurality of types of sheet processing, and different discharge destinations are used for the respective types of processing.

Further, let it be assumed that the printing system 1000 having the system configuration shown in FIG. 3 receives a job associated with a printing execution request from the user and that the user has designated execution of sheet processing by the inserter 200-3d. The job associated with sheet processing by the inserter 200-3d is hereafter referred to as “the inserter feed job”. The inserter feed job can be configured such that only post processing is executed using any of connected sheet processing apparatuses downstream of the printing apparatus 100.

In the case of processing the inserter feed job by the system configured as in FIG. 3, the controller 205 causes sheets fed by the inserter 200-3d to be inserted between sheets printed by the printing apparatus 100 and then convey them, according to a designated type of sheet processing, to a sheet processing apparatus associated with the designated sheet processing, followed by causing the sheet processing apparatus to execute the sheet processing. In FIG. 3, the glue binding machine 200-3b and the saddle stitching machine 200-3c are sequentially connected to the inserter 200-3d disposed upstream of them, so that the inserter feed job can be processed for the glue binding job or the saddle-stitch job. It should be noted that the inserter feed job does not necessarily involve printing by the printing apparatus 100. More specifically, it is possible to convey only sheets fed from the inserter 200-3d downstream and carry out sheet processing using a designated sheet processing apparatus.

As described with reference to FIGS. 1 to 3, the printing system 1000 according to the present embodiment is configured such that a plurality of sheet processing apparatuses can be sequentially connected to the printing apparatus 100. A pattern of combination of sheet processing apparatuses to be connected to the printing apparatus 100 can be selected as desired. Further, it is possible to change the connection order of sheet processing apparatuses as desired insofar as the sheet conveying paths of the respective sheet processing apparatuses can be sequentially connected to one another. As is apparent from the above description, candidate apparatuses for connection to the printing apparatus 100 are not limited to a single kind.

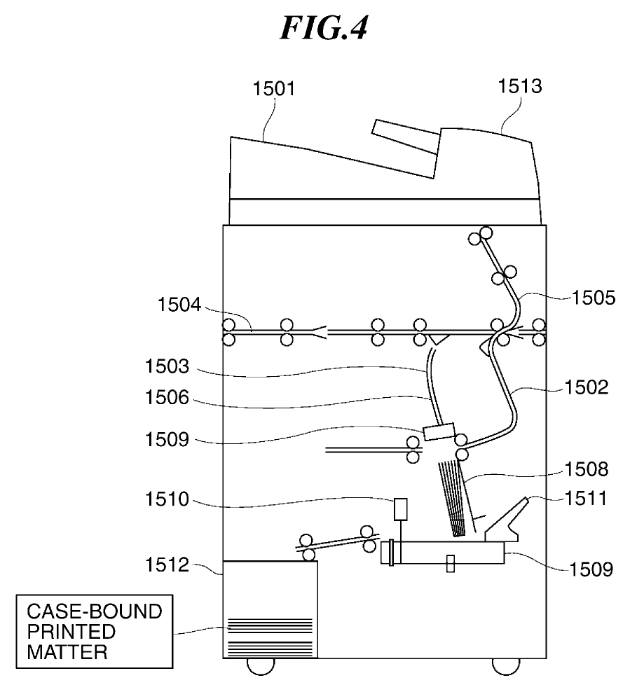

Next, a description will be given of the sheet processing apparatuses 200 that can be connected to the printing system 100, type by type, with reference to FIG. 4 and so forth.

First, a description will be given of the internal construction of the glue binding machine, using a cross-sectional view shown in FIG. 4.

The glue binding machine selectively conveys sheets from an upstream apparatus into one of three conveying paths. One of the conveying paths is a cover sheet-conveying path 1502, another is a book body-conveying path 1503, and the other is a straight path 1504. Further, the glue binding machine has an inserter path 1505. The inserter path 1505 is a sheet conveying path for conveying sheets set on an insert tray 1501 into the cover sheet-conveying path 1502.

The straight path 1504 of the glue binding machine shown in FIG. 5 is a sheet conveying path for conveying sheets associated with a job which does not require glue binding by the glue binding machine to a downstream apparatus. Further, the book body-conveying path 1503 and the cover sheet-conveying path 1502 of the glue binding machine shown in FIG. 5 are sheet conveying paths for conveying sheets necessitated for creation of a case-bound printed matter.

For example, when instructed to perform case binding using the glue binding machine, first, the controller 205 performs control such that sheets to form a book body of the case-bound printed matter are printed with image data for the book body by the printer section 203. In the case of creating a case-bound printed matter corresponding to one volume, a bundle of the book-body sheets corresponding to one volume is covered by a single cover sheet. The book-body sheet bundle for case binding is hereafter referred to as “the book body”.

Next, the controller 205 performs control such that sheets which are printed by the printing system 100 to form a book body are conveyed to the book body-conveying path 1503. Then, when performing case binding, the controller 205 causes the sheets for the book body to be covered with the cover sheet conveyed through the cover sheet-conveying path 1502.

For example, the controller 205 performs control such that sheets conveyed from the insert tray 1501 for forming the book body are sequentially conveyed through the book body-conveying path 1503 to be stacked in a stacker section 1506. When a number of sheets corresponding to one volume and having main-body data printed thereon are stacked in the stacker section 1506, the controller 205 performs control such that a single sheet to be used as a cover in the job is conveyed through the covet sheet-conveying path 1502. Then, the controller 205 controls a gluing section 1507, appearing in FIG. 4, to perform gluing on a spine-side edge portion of the sheet bundle as one set of sheets corresponding to the book body. Thereafter, the controller 205 causes the gluing section 1507 to glue the spine-side edge portion of the book body and the central portion of the cover sheet to each other. In the case of gluing the book body to the cover sheet, the book body is conveyed while being pressed downward in the glue binding machine. As a consequence, the cover sheet is folded in a manner covering the book body.

Thereafter, the sheet bundle as one set of sheets is stacked on a rotary table 1509 appearing in FIG. 4 along a guide 1508. When the sheet bundle is set on the rotary table 1509, the controller 205 causes a cutter section 1510 in FIG. 4 to perform cutting on the sheet bundle. In this case, it is possible to cause the cutter section 1510 to execute three-way cutting for cutting three edges of the sheet bundle except for the spine-side edge thereof. Then, the controller 205 causes the sheet bundle having undergone the three-way cutting to be pushed out toward a basket 1512 using a free space-reducing section 1511 so as to be stored therein.

Further, the glue binding machine not only processes the sheets conveyed from an upstream apparatus, but also performs case binding or top gluing singly. For example, a description will be given, by way of example, based on a case where a case-bound printed matter is prepared using the glue binding machine. First, the set sets sheets to be processed on the insert tray 1501 appearing in FIG. 4. Then, the controller 205 causes an inserter section 1513 to feed the sheets set on the insert tray 1501 and cause them to be guided into book body-conveying path 1503 appearing in FIG. 4, to form a book body. Then, the controller 205 causes a sheet cover fed from the same insert tray 1501 to be conveyed via the cover sheet-conveying path 1502, and the execute case binding of the body. Processing subsequent thereto is the same as described hereinabove.

Further, sheets can be also fed into the glue binding machine from the inserter 200-3d.

Next, a description will be given, by way of example, based on a case where a glue-bound printed matter is delivered by a combination of the inserter 200-3d and the glue binding machine 200-3b.

First, the user sets sheets for bookbinding on at least one of a first feed deck 1804, a second feed deck 1805, and a third feed deck 1806 within the inserter 200-3d. In the present example, it is assumed that product sheets each for forming a cover are set in the first feed deck 1804, and sheets for forming a book body are set in the second feed deck 1805. Then, the controller 205 causes the sheets set in the second feed deck 1805 for forming a book body to be fed and conveyed to the straight path 1504 and then into the book body-conveying path 1503 of the glue binding machine 200-3b, to form a book body. Then, the controller 205 similarly causes a sheet for a cover to be fed from the first feed deck 1804 and conveyed into the cover sheet-conveying path 1502, and then causes the book body to be covered with the sheet for a cover. Processing subsequent thereto is the same as described hereinabove.

Next, a description will be given of the construction of the operating section 204 with reference to FIG. 5.

The operating section 204 includes the touch panel section 401, and the key input section 402. The touch panel section 401 is comprised of an LCD (Liquid Crystal Display) and a transparent electrode attached to the upper surface thereof, for displaying various configuration screens for receiving instructions from the user. The touch panel section 401 has both of the function of displaying various screens and an instruction receiving function of receiving instructions from the user.

On the touch panel section 401 are displayed a copy key 601, a send key 602, a box key 603, an option key 604, an automatic color selection key 605, and a direct/zoom key 608. Further, on the touch panel section 401 are displayed a sheet processing configuration key 609, a double-sided printing key 614, a paper selection key 615, a system status/stop key 617, an application mode key 618, etc. The key input section 402 is provided with a power key 501, a start key 503, a stop key 502, a user mode key 505, and a ten-key pad 506. The starter key 503 is used when causing the printing apparatus 100 to start execution of a copy job or a transmission. The ten-key pad 506 is used for setting a numerical input, such as a number of printed copies.

The controller 205 controls the printing system 1000 such that various processes are carried out based on user instructions received via various screens displayed on the touch panel section 401 and user instructions received via the key input section 402.

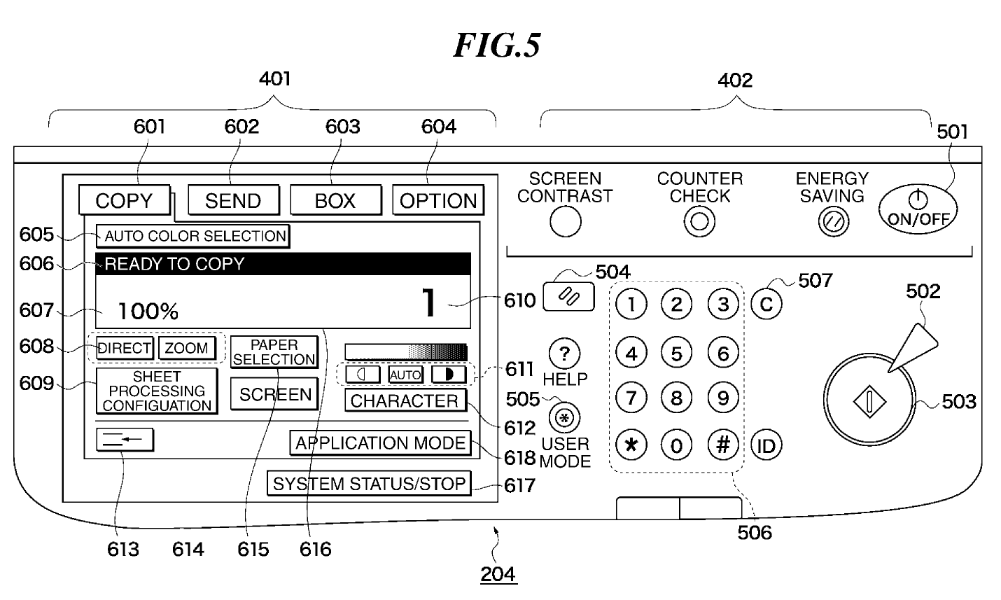

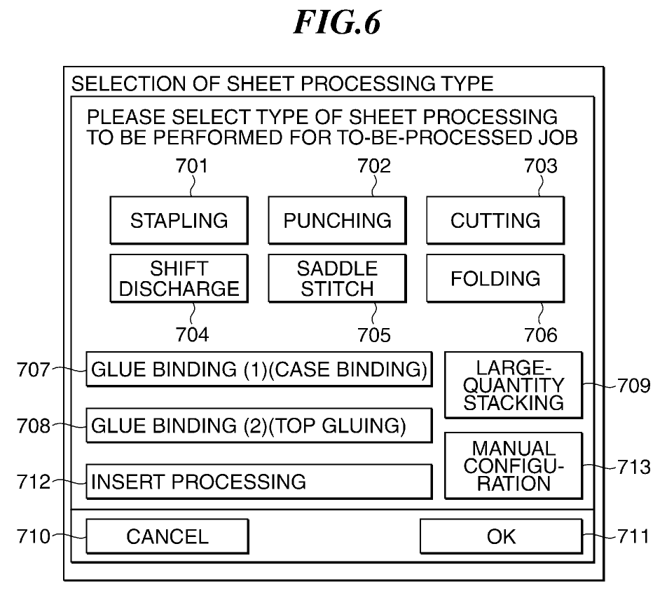

FIG. 6 is a view illustrating an example of a configuration screen displayed so as to cause the user to select the type of sheet processing to be executed on sheets printed by the printing apparatus 100. On the FIG. 6 screen, there are displayed a button (soft key) 701 for designating stapling, a button (soft key) 702 for designating punching, a button (soft key) 703 for designating cutting, a button (soft key) 704 for designating shift discharging, and a button (soft key) 705 for designating saddle-stitch processing. Further, there are a button (soft key) 706 for designating Z-folding, a button (soft key) 707 for designating glue binding (1) (case binding), and a button (soft key) 708 for designating glue binding (2) (top gluing). Furthermore, there are displayed a button (soft key) 709 for designating large-quantity stack processing, a button (soft key) 712 for designating insert processing, a manual configuration button (soft key) 713, a cancel button (soft key) 710, and an OK button (soft key) 711.

When the user presses the sheet processing configuration key 609, appearing in FIG. 5, on the screen displayed on the touch panel section 401 of the operating section 204, the controller 205 displays the screen shown in FIG. 6 on the touch panel section 401. The FIG. 6 screen is a configuration screen which is configured to enable the user to select a desired type of sheet processing that can be executed using an associated one of the sheet processing apparatuses 200 incorporated in the printing system 1000. The controller 205 receives settings of sheet processing to be executed in a to-be-processed job, from the user, via this FIG. 6 screen, and causes the sheet processing apparatuses 200 to execute the sheet processing based on the settings.

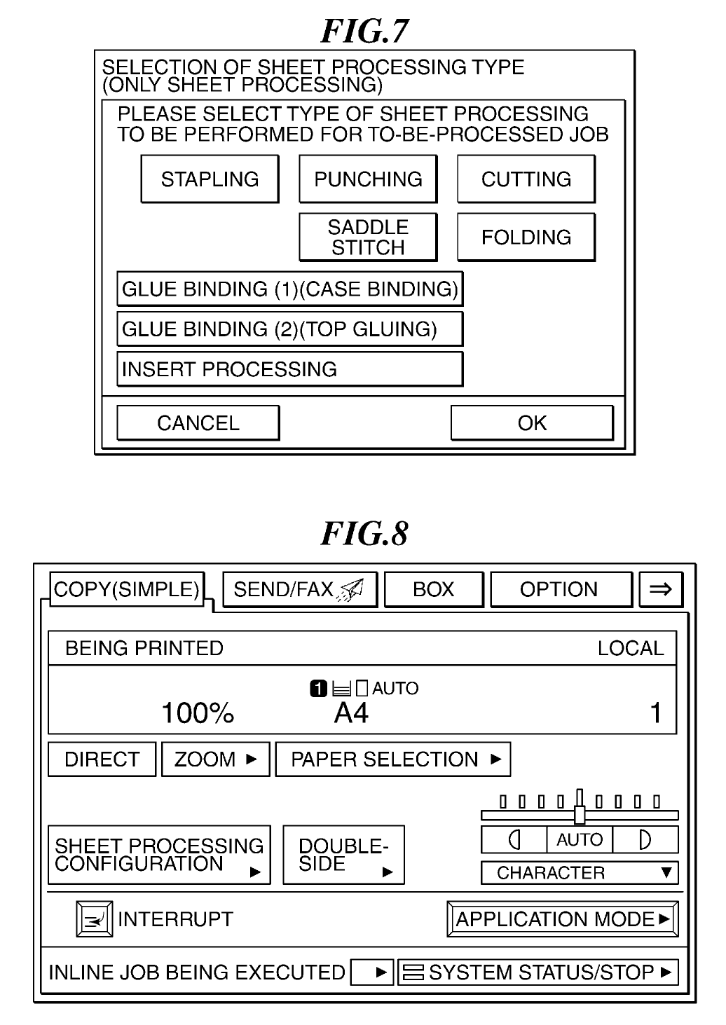

FIG. 7 is an example of display of a configuration screen for enabling a user to select a desired type of sheet processing that can be executed singly by an associated one of the sheet processing apparatuses 200. When the manual configuration key 713 in the screen displayed on the touch panel section 401 as shown in FIG. 6 is pressed, the controller 205 causes the FIG. 7 screen to be displayed on the touch panel section 401. The FIG. 7 screen is a configuration screen configured to enable the user to selected a desired one of types of sheet processing that can be executed singly by the sheet processing apparatus 200 incorporated in the printing system 1000. The controller 205 receives, via the FIG. 7 screen, settings of sheet processing to be executed in the to-be-processed job, from the user, and causes the sheet processing apparatus 200 to execute the sheet processing according to the settings.

In the case of the sheet processing apparatus 200 being connected to the printing apparatus 100, the printing system 1000 may be configured such that the user can store information for determining how many sheet processing apparatuses of what types are to be connected in what order, in the HDD 209.

Let us consider, for example, a case where the printing system 1000 is configured as shown in FIG. 3. At this time, registration information is set which shows that four sheet processing apparatuses, i.e. a large-capacity stacker, an inserter, a glue binding machine, and a saddle stitching machine, are serially connected to the printing apparatus 100. The controller 205 causes information on settings of the sheet processing apparatuses 200 configured by the user to be stored in the RAM 208 as system configuration information, and reads out the same for reference as required. The controller 205 thus confirms how many sheet processing apparatuses of what types are connected to the printing apparatus 100 in what order, and the like.

In this connection, let it be assumed that a user has configured connection of a plurality of sheet processing apparatuses such that the saddle stitching machine having no straight path 1504 is connected at an intermediate location between the sheet processing apparatuses. In this case, the controller 205 causes the touch panel section 401 of the operating section 204 to display an error message notifying the user that the configuration is made invalid. Further, the controller 205 causes guidance information to be displayed on the touch panel section 401 for notifying the user that the apparatus connection should not be configured as such, but the saddle stitching machine should be connected to the trailing end of the sequence of the sheet processing apparatuses.

In the present embodiment, the operating section 204 provided on the printing apparatus 100 is illustrated as a user interface applied to the printing system 1000, by way of example, but the user interface may be other than this. For example, the printing system 1000 may be configured such that it can execute processing based on instructions input by the user via a user interface provided on any of external apparatuses, such as the PC 103 and the PC 104. When the printing system 1000 is thus remotely operated from an external apparatus, a configuration screen concerning the printing system 1000 is displayed on a display section of the apparatus.

A description will be given by taking the PC 104 as an example. When a printing request is received from the user, the CPU provided in the PC 104 causes the configuration screen to be displayed on a display thereof, and via the screen, settings of print processing conditions are received from the user of the PC 104. Then, upon reception of a printing execution request from the user, the CPU of the PC 104 associates the print processing conditions received via the screen and image data to be printed, and performs control such that the image data and the print processing conditions associated therewith are transmitted to the printing system 1000 as a job over the network 101.

On the other hand, in the printing system 1000, upon reception of a printing execution request of the job via the external interface 202, the controller 205 controls the printing system 1000 such that the job from the PC 104 is processed based on the print processing conditions from the PC 104. Thus, it is possible to provide various units, as user interfaces for the printing system 1000.

Next, hereafter, a description will be given of various controls which are carried out for the printing system 1000 by the controller 205 as an example of a control section in the present embodiment.

It should be noted that the printing system 1000 is provided with the printing apparatus 100 which includes the HDD 209 capable of storing data of a plurality of jobs, and the printer section 203 capable of executing print processing on data in the HDD 209. Further, the printing system 1000 is configured such that the printing apparatus 100 and a plurality of sheet processing apparatuses 200 can be connected. Further, the sheet processing apparatuses 200 connectible to the printing apparatus 100 are each configured be capable of performing sheet processing on sheets of a job subjected to printing by the printer section 203 (also referred to as a printout or a printed material)

Further, these sheet processing apparatuses 200 are each configured such that the user can take out a printed material on which sheet processing has been performed by the apparatus 200. Further, the inserter 200-3d, as one of these sheet processing apparatuses, is configured to be internally provided with the first feed deck 1804, the second feed deck 1805, and the third feed deck 1806. The inserter 200-3d is configured to be capable of selectively feeding sheets from at least one of these feed decks to the plurality of sheet processing apparatuses, according to settings associated with the sheets.

Further, the printing system 1000 in the present embodiment is configured to be capable of selectively feeding sheets of a job subjected to printing by the printer section 203 from the printer section 203 to these sheet processing apparatuses. Further, the printing system 1000 has the function of processing a job using a selected one of the sheet processing apparatuses alone without using the printing apparatus 100. The controller 205 controls the printing system 1000 such that for each to-be-processed job, processing can be selectively performed between the processing using the sheet processing apparatus 200 alone (i.e. singly by the sheet processing apparatus 200) and processing using the printing apparatus 100 and the sheet processing apparatus 200, based on instructions by the user from an user interface section (UI section). Further, the controller 205 is also capable of controlling the printing system 1000 such that these two types of processing can be executed in a combined manner, depending on the case.

The printing system 1000 according to the present embodiment is provided with a flexible and/or user-friendly mechanism which makes it possible to utilize post processing executed by a post-processing unit connected to a printing unit, without involving printing by the printing unit.

For example, insofar as this mechanism is concerned, the printing system 1000 according to the present embodiment is provided with an execution request receiving unit for receiving a request for execution of a specific-type job in which post processing by a post-processing unit connected to the printing unit is executed without execution of printing by the printing unit.

In the present embodiment, the printer section 203 and/or the printing apparatus 100 functions as the printing unit, and a sheet processing apparatus 200 (e.g. at least one of the sheet processing apparatuses shown in FIG. 3) connected to the printing apparatus 100 functions as the post-processing unit.

Further, in the present embodiment, a job requiring sheet processing (hereinafter referred to as “post processing”) by the sheet processing apparatus 200 without involving printing by the printer section 203 will be described as the specific-type job, by way of example. For example, a job for executing post processing by a sheet processing apparatus 200 without involving printing by the printing apparatus 100 is handled as the specific-type job.

Thus, in the present embodiment, a job requiring execution of post processing by a sheet processing apparatus 200 independently of (in a manner asynchronous/interlocked with) print processing by the printing apparatus 100 is handled as the specific-type job. The controller 205 performs control such that the specific-type job can be processed by the printing system 1000.

The types of post processing permitted to be executed in the specific-type job in the present embodiment can be listed as follows:

(1) stapling

(2) punching

(3) cutting

(4) saddle-stitch processing

(5) folding

(6) case binding

(7) top gluing

(8) insert processing

In the present embodiment, the post-processing operations (1) to (5) can be selectively executed by a saddle stitching machine (corresponding to the saddle stitching machine 200-3c of the sheet processing apparatuses 200 in FIG. 3). The post-processing operations (6) and (7) can be selectively carried out by a glue binding machine in FIG. 4 (corresponding to the glue binding machine 200-3b of the sheet processing apparatuses 200 in FIG. 3). Further, the post-processing operation (8) can be carried out by a large-capacity inserter in FIG. 8 (corresponding to the inserter 200-3d of the sheet processing apparatuses 200 in FIG. 3).

Post-processing operations that can be executed without involving printing are not limited to the above examples, but may include any other suitable type of post processing. Further, although in the above example, the printing system is configured to be capable of selectively executing the multiple types of post-processing operations, this is not limitative, but the printing system may be configured to be capable of executing only a single post-processing operation without involving printing.

In the present embodiment, various user interfaces that are provided by the printing system 1000 and are configured to be interactively responsive to a user operation function as the above-mentioned execution request receiving unit. For example, the operating section 204 and/or soft keys and hard keys provided in the operating section 204, and/or various illustrated user interface screens can be mentioned as examples of the execution request receiving unit. However, these are only exemplary.

For example, a request for execution of the specific-type job may also be received by an external apparatus different from the printing system 1000. In this case, a user interface provided in an external data generating source, such as the scanner 102, the PC 103, or the PC 104, functions as a receiving unit for receiving the execution request. Further, in this case, a unit, such as the external interface 202 that the printing system 1000 necessarily uses to externally receive the specific-type job, also functions as a receiving unit for receiving the execution request.

As described above, it is possible to make various changes and modifications to the present embodiment, and therefore the present invention can be applied to any printing system insofar as it has at least a configuration equivalent to that of the printing system 1000, which will be described below.

For example, let it be assumed that the controller 205 receives a request for execution of the specific-type job via one of the above-mentioned user interfaces. In this case, in response to the execution request, the controller 205 causes an associated sheet processing apparatus 200 to execute post processing on a printout (first printout) prepared for the specific-type job, without causing the printing apparatus 100 to perform printing.

As described above, the printing system 1000 has a control unit configured to be operable when receiving the above-mentioned request for execution of the specific-type job, to cause the post-processing unit to execute the post processing on the first printout prepared for the specific-type job, without causing the printing unit to perform printing. In the present embodiment, this control unit is implemented by the controller 205.

It should be noted that in the present embodiment, each of the sheet processing apparatuses 200 themselves is provided with a predetermined supply unit configured to be capable of supplying a plurality of printing media (printout) printed in advance as the first printout. The large-capacity stacker 200-3a, the saddle stitching machine 200-3c, and the large-capacity inserter 200-3d, which are shown as sheet processing apparatuses 200 in FIGS. 3 and 4, respectively, are provided with the inserter section 1513, and the first to third feed decks 1804 to 1806, respectively. In the present embodiment, each of these units not only performs the associated function described at the beginning of the present detailed description, but also functions as the predetermined supply unit (sheet feed unit). The first printout required for the specific-type job is set on a selected one of these predetermined sheet feed units by the user.

Then, in the present embodiment, when a request for execution of the specific-type job is issued by the user, the controller 205 performs control such that the first printout is supplied from the supply unit to a post-processing section within the sheet processing apparatus 200 without being passed through the printing unit. Thereafter, the controller 205 causes the post-processing section to execute the post processing on the first printout. With this method, the controller 205 can cause the sheet processing apparatus 200 to execute a post-processing operation designated by the user for the job without involving printing by the printing apparatus 100.

It should be noted that when the specific-type job is to be executed, the first printout may be supplied from a sheet feed cassette as a predetermined supply unit provided in the printing apparatus 100. In this case, while the first printout is being guided through the conveying path in the printing apparatus 100 toward the sheet processing apparatus 200, the controller 205 performs control such that printing of the first printout by the printing apparatus 100 is disabled, and when the printout has been conveyed into the sheet processing apparatus 200, the controller 205 controls the sheet processing apparatus 200 to execute the sheet processing designated by the user on the printout.

Further, in the present embodiment, when the print processing by the printing apparatus 100 is temporarily stopped, if the cause for stopping the print processing does not hinder the operation of the post-processing section, the controller 208 causes a message notifying the user that the execution of the post processing is permitted to be displayed on the user interface. As an example of this, the present printing system 1000 is configured as described hereinafter with reference to FIGS. 8 to 13.

FIG. 8 is a diagram showing an example of a screen displayed on the printing system 100 for notifying that the printing system 100 is executing printing. When the start key 503 is pressed by the user with the copy key 601 pressed, which appears in the screen displayed on the touch panel section 401 of the operating section 204 in FIG. 5, the controller 205 causes the FIG.8 screen to be displayed on the touch panel section 401. The FIG. 8 screen is configured to be displayed when the print processing is being executed by the printing apparatus 100 (INLINE JOB BEING EXECUTED). The controller 205 accepts settings of print processing in a to-be-processed job via the FIG. 8 screen, and causes the print processing to be executed by the printing apparatus according to the settings.

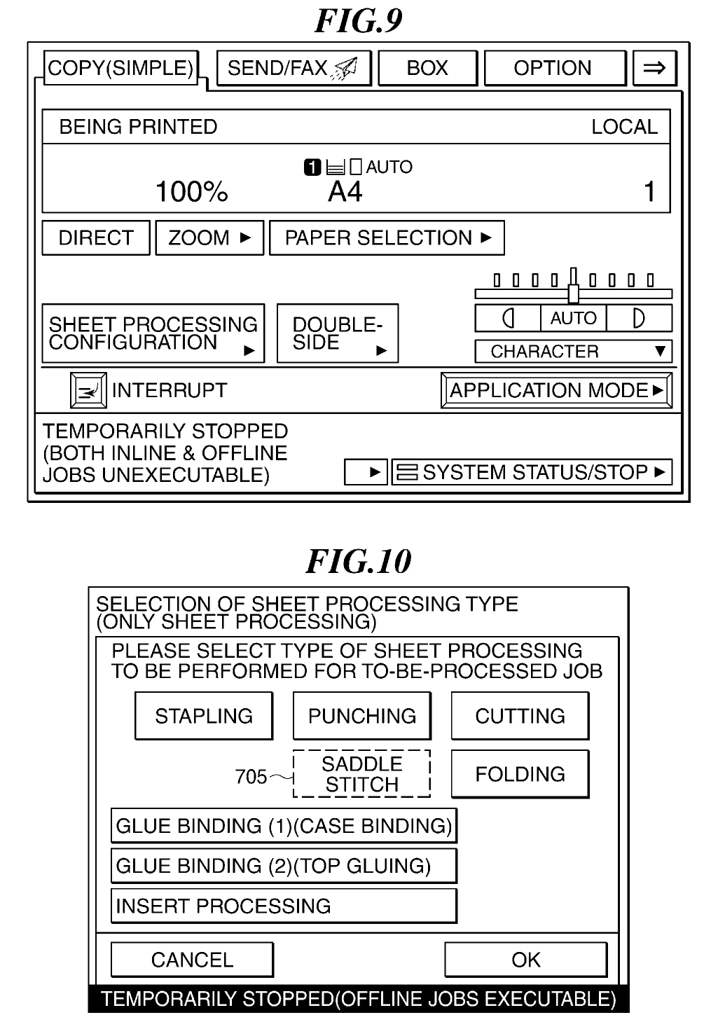

FIG. 9 is a diagram showing an example of a screen displayed on the printing system 100 for notifying that printing by the printing system 100 is temporarily stopped. When a cause for temporarily stopping the operation of the printing apparatus 100 (e.g. paper jam removal, adjustment of image formation, running out of paper, etc.) is detected, the controller 208 causes the FIG. 9 screen to be displayed on the touch panel section 401. The FIG. 9 screen is configured to display a message notifying that the print processing by the printing apparatus 100 is temporarily stopped (TEMPORARY STOPPED (BOTH INLINE & OFFLINE JOBS UNEXECUTABLE)). When the printing apparatus 100 is temporarily stopped, the controller 205 causes the FIG. 9 screen to be displayed, thereby notifying the user that the operation of the printing apparatus 100 is temporarily stopped.

Similarly to FIG. 7, FIG. 10 shows an example of display of a configuration screen for enabling a user to select a desired type of sheet processing to be performed on printed sheets. When a cause for temporarily stopping the operation of the printing apparatus 100 (e.g. paper jam removal, adjustment of image formation, running out of paper, etc.) is detected during execution of the print processing, the controller 208 causes the FIG. 10 screen to be displayed on the touch panel section 401. At this time, the controller 205 detects the temporary stop cause, and performs control such that this screen is displayed with buttons thereon associated with unexecutable types of sheet processing being made inoperative (hereinafter referred to as “grayed out”).

In the illustrated example, the printing apparatus 100 is temporarily stopped during saddle stitching using the saddle stitching machine 200-3c, so that the screen is displayed on the touch panel section 401 with the saddle stitching button 705 being grayed out (represented by a rectangle of dotted lines in FIG. 10). The FIG. 10 screen is configured to display buttons (respective buttons for designating stapling, punching, cutting, etc.) and a message saying that the print processing is temporarily stopped (TEMPORARILY STOPPED (OFFLINE JOBS EXECUTABLE)).

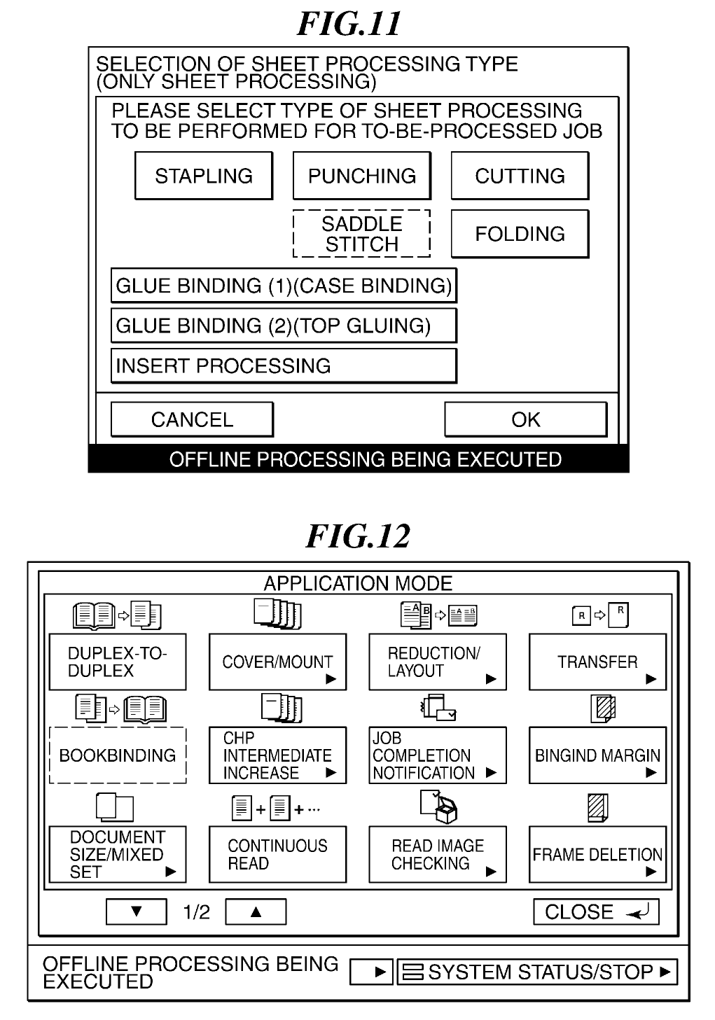

Similarly to FIG. 10, FIG. 11 shows an example of display of a configuration screen for enabling a user to select a desired one of types of sheet processing to be performed on printed sheets. After the printing system 100 detects a temporary stop cause that has occurred during execution of the print processing, if execution of sheet processing designated by the user via the FIG. 10 screen is started, the controller 205 causes the FIG. 11 screen to be displayed on the touch panel 401. This screen also displays respective buttons associated with types of sheet processing the execution of which is hindered by the temporary stop cause that has temporarily stopped the operation of the printing apparatus 100 each in an inoperative state, thereby permitting execution of sheet processing designated by the user from the FIG. 11 screen.

In the illustrated example, it is assumed that sheet processing of the glue binding (1) (case binding) is designated and the printing system 1000 executes the sheet processing using the insert 200-3d and the glue binding machine 200-3b in combination. The operations of the printing system 1000 for this sheet processing are described hereinabove.

FIG. 12 is a diagram showing an example of a configuration screen displayed when sheet processing(an offline job) is being executed, for enabling a user to perform selection from a displayed list of printing functions that can be set from the printing apparatus 100. In this screen, buttons for processing being executed using sheet processing apparatuses 200 are displayed in a grayed out state for inhibiting the use of the associated functions. In the illustrated example, a bookbinding button, which is associated with the glue binding machine 200-3d and the saddle stitching machine 200-3c, is grayed out (represented by a rectangle of dotted lines in FIG. 12) to prevent the functions thereof from being used.

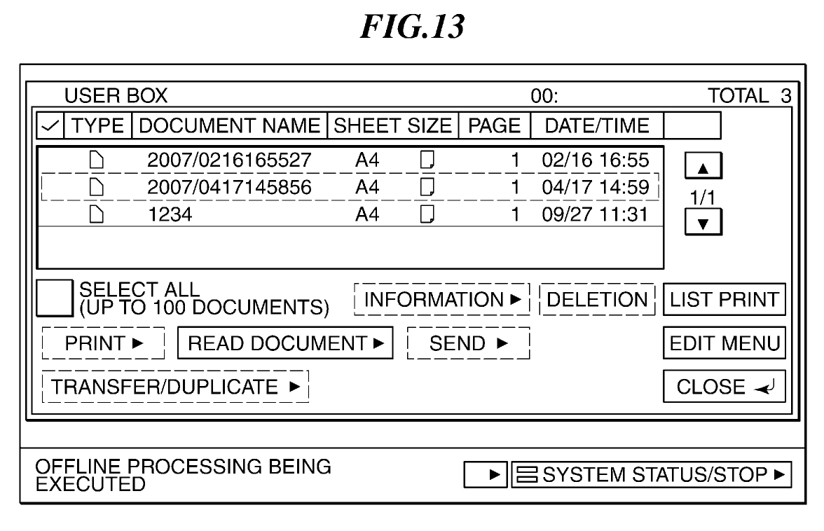

FIG. 13 is a diagram showing an example of a configuration screen displayed for enabling a user to perform selection from a list of documents stored in the HDD 209 of the printing apparatus 100, in a state permitting execution of printing. In this screen, as for a type of processing being executed using a sheet processing apparatus 200, a document per se which involves the type of processing is illustrated in a grayed out state (represented by a rectangle of dotted lines in FIG. 13) for inhibiting execution of the document. In the illustrated example, settings of this document include the use of the function of the glue binding machine 200-3b, and hence the document is displayed in a grayed-out state.

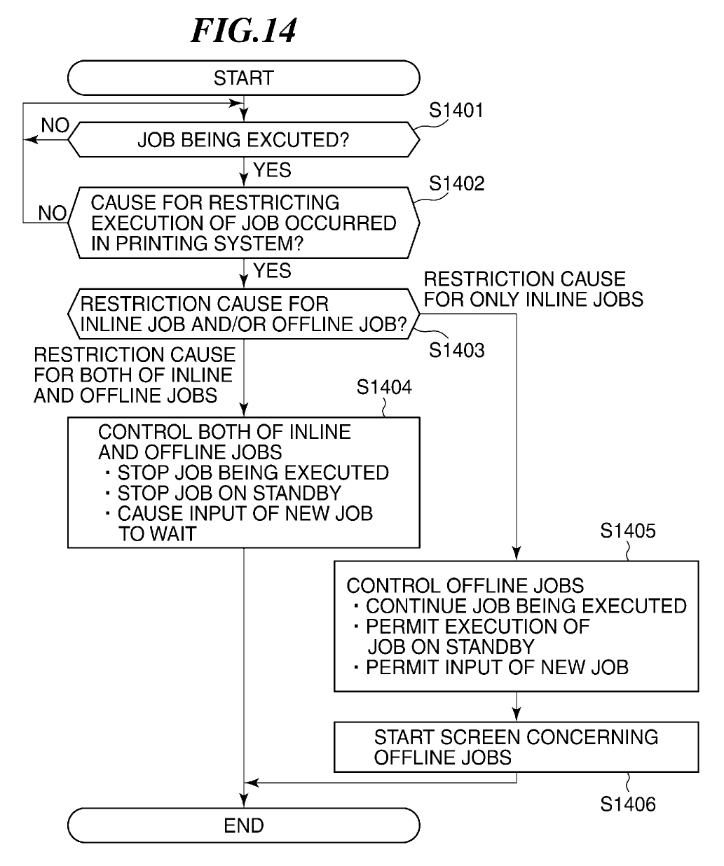

Next, a description will be given of a control process executed when the controller 205 detects a temporary stop cause during execution of a to-be-executed job in the present embodiment, with reference to a flowchart in FIG. 14. Steps shown in the FIG. 14 flowchart are carried out by the controller 205 that executes an associated program stored in the ROM 207 or the HDD 209.

In a step S1401, the controller 205 of the printing apparatus 100 determines whether or not a job is being executed. If a job is being executed, the process proceeds to a step S1402, whereas if not, the step S1401 is executed again.

In the step S1402, the controller 205 determines whether an execution restriction cause (stop cause) for stopping the job being executed has occurred in the printing system 1000. When detecting notification of a temporary stop from within the printing system 100, the controller 205 determines a situation. If any restriction cause has occurred, the process proceeds to a step S1403, whereas if not, the process returns to the step S1401.

In the step S1403, the controller 205 determines whether the restriction cause occurrence of which is determined in the step S1402 is a cause for restricting execution of an inline job and/or an offline job. If the cause restricts both of inline and offline jobs, the process proceeds to a step S1404, whereas if not, and the cause is specific to an inline job, the process proceeds to a step S1405.

The cause for restricting execution of both of inline and offline jobs is e.g. mechanical disconnection of the sheet processing apparatuses 200 from the printing apparatus 100. In this case, the controller 205 cannot cause sheets printed by the printing apparatus 100 to be conveyed into the large-capacity stacker 200-3a, which makes it possible to normally discharge a printed material, and hence the controller 205 determines that it is a cause for restricting execution of both of inline jobs and offline jobs.

Further, disconnection of a communication path between the printing apparatus 100 and the sheet processing apparatuses 200 is also considered as a cause for restricting execution of both of inline jobs and offline jobs. In this case, even if the controller 205 conveys sheets printed by the printing apparatus 100 to the large-capacity stacker 200-3a, and attempts to send to the large-capacity stacker 200-3a an instruction for causing the large-capacity stacker 200-3a to convey the sheets, the instruction cannot be sent. Therefore, the disconnection of the communication path between the printing apparatus 100 and the sheet processing apparatuses 200 is considered as a cause for restricting execution of both of inline jobs and offline jobs. It should be noted that the cause for restricting execution of both of inline jobs and offline jobs may be other than these.

Further, the restriction cause specific to inline jobs includes e.g. a paper jam in a sheet conveying path within the printing apparatus 100, and shortage of toner of the printing apparatus 100. In this case, it is possible to execute an offline job in which the sheets fed from the inserter 200-3d are processed by one of connected sheet processing apparatuses downstream of the inserter 200-3d. Therefore, the process proceeds to the step S1405, wherein the controller 205 performs control such that executable offline jobs are executed.

In the step S1404, the controller performs control such that both of inline jobs and offline jobs are inhibited from being executed. Specifically, if any inline or offline job is being executed, the inline or the offline job being executed is stopped. Further, the controller 205 prevents an inline or offline job on standby (in a state waiting for printing), if any, which is stored in a memory, such as the HDD 209, from being executed. Further, the controller 205 causes an inline or offline job input a new to be stored in the HDD 209 or the like, and be made on standby so as to prevent the same from being executed.

Alternatively, the controller 205 may inhibit reception of an inline or offline job which is to be input anew, and notify the user that the job is not allowed to be received, via the operating section 204, in the step S1404.

In the step S1405, the controller 205 performs control such that offline jobs are executed. Specifically, if an inline job being executed, the controller 205 causes the inline job to be stopped. Further, if an offline job is being executed, the controller 205 causes execution of the offline job to be continued.

Further, the controller 205 causes inline jobs which are stored in a memory, such as the HDD, and on standby (in a state waiting for printing), to be prevented from being executed until the cause for restricting execution of inline jobs is eliminated. On the other hand, the controller 205 causes offline jobs which are stored in a memory, such as the HDD 209, and on standby (in a state waiting for printing), to be made on standby in an executable state, and when it is a standby offline job' turn to be executed, the offline job is executed. Further, the controller 205 inhibits input of a new inline job, whereas it enables input of a new offline job and causes the input offline job to be stored in a memory, such as the HDD 209, in a state waiting for processing.

When performing control such that an inline job is not received, the controller 205 may notify the user attempted to input the inline job that the inline job is not allowed to be received, via the operating section 204. After executing the step S1405, the process proceeds to a step S1406.

In the step S1406, the controller 205 starts a screen appropriate for causing an offline job to be executed, automatically or manually by an operation of the user, and causes the screen to be displayed. Specifically, the controller 205 causes the FIG. 10 screen, from which an offline job can be set, to be displayed on the touch panel section 401 of the operating section 204.

As described heretofore, according to the present embodiment, in the printing system 1000, which is configured such that the printing system 100 and the sheet processing apparatuses 200 are connected, it is possible to cause sheet processing to be executed singly using a selected one of the sheet processing apparatuses 200, without using the printing apparatus 100. This makes it possible to improve the productivity of the sheet processing apparatuses 200, aside from the availability of the printing apparatus 100. Further, when print processing using the printing apparatus 100 and any of the sheet processing apparatuses 200 in combination is being executed, if the cause for temporarily stopping the print processing is not a cause which hinders execution of sheet processing singly by a sheet processing apparatus 200, the sheet processing can be executed singly by the sheet processing apparatus 200. This makes it possible to further improve the productivity of the sheet processing apparatuses 200. In accordance therewith, it is possible to improve the efficiency of operations involving sheet processing.

Further, inline jobs which are controlled in the above-described step S1406 in the FIG. 14 flowchart such that they are prevented from being executed until the cause for restricting execution of inline jobs is eliminated, are executed again by the controller 205 after elimination of the cause. In doing this, if the controller 205 has an offline job being executed, and further the offline job can be executed in parallel with an inline job, the inline job is executed while executing the offline job. On the other hand, if the controller 205 has an offline job being executed, and the offline cannot be executed in parallel with an inline job, the controller 205 causes the inline job to be executed after waiting for completion of the offline job. A case where an offline job being executed can be executed in parallel with an inline job is e.g. a case where a post-processing unit being used by the offline job is located downstream of a post-processing unit to be used by the inline job. In this case, sheets conveyed by execution of the offline job do not overlap (do not meet) sheets conveyed by execution of the inline job, and hence, the units can be operated in parallel. On the other hand, a case where an offline being executed cannot be executed in parallel with an inline job is e.g. a case where a post-processing unit being used by the offline job is the same as a post-processing unit to be used by the inline job. Alternatively, it is a case where a post-processing unit being used by the offline job is located upstream of a post-processing unit to be used by the inline job. In this case, there is a fear that sheets conveyed by execution of the offline job overlap (meet) sheets conveyed by execution of the inline job, and hence, they can be executed in parallel.

More specifically, when resuming execution of the inline job, the controller 205 identifies a relation between the post-processing unit used by the offline job being executed and the post-processing unit to be used by the inline job, by referring to information on the order of connection of the post-processing units or the like, which is stored in the HDD 209. Then, when determining that sheets being processed by the offline job being executed and sheets to be processed by the inline job to be resumed do not meet (the post-processing unit being used by the offline job is downstream of the post-processing unit to be used by the inline job), the controller 205 causes execution of the inline job to be resumed while continuing the execution of the offline job. On the other hand, when determining that sheets being processed by the offline job being executed and sheets to be processed by the inline job to be resumed meet (the post-processing unit being used by the offline job is not downstream of the post-processing unit to be used by the inline job), the controller 205 causes execution of the inline job to be resumed after waiting for completion of the offline job.

By performing such control, when resuming the execution of the inline job the execution of which is restricted by a restriction cause, it is possible to prevent sheets associated with the inline job the execution of which is resumed from overlapping (meeting) sheets associated with the offline job being executed. Therefore, when resuming an inline job the execution of which is restricted by a restriction cause, it is possible to appropriately control job execution timing, by considering a post-processing unit being used by an offline job.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g. computer-readable medium).

The present invention is not limited to the embodiment exemplified in FIGS. 1 to 14, but a lot of variations (including well-organized combinations of the embodiments of the present invention) are possible based on the subject matter of the present invention, and they should not be excluded from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-221789 filed Aug. 29, 2008, which is hereby incorporated by reference herein in its entirety.

What is claimed is:

1. A printing system that conveys sheets printed by a printing unit to a sheet processing unit connected to the printing unit and causes the sheet processing unit to perform post processing on the sheet, comprising:
an execution unit configured to execute either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed On the sheets by the post-processing unit; and
a control unit configured to permit execution of an executable offline job when the inline job being executed by said execution unit is temporarily stopped.

2. The printing system according to claim 1, wherein when the inline job executed by said execution unit is brought to a temporary stop, and if a cause for the temporary stop is not a cause which hinders execution of the offline job, said control unit performs control such that execution of an offline job being currently executed is continued.

3. The printing system according to claim 2, wherein when the inline job executed by said execution unit is brought to a temporary stop, and if a cause for the temporary stop is not a cause which hinders execution of the offline job, said control unit performs control such that a screen for causing an offline job to be executed is started.

4. A method of controlling a printing system that conveys sheets printed by a printing unit to a sheet processing unit connected to the printing unit and causes the sheet processing unit to perform post processing on the sheet, comprising:
executing either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed on the sheets by the post-processing unit; and
permitting execution of an executable offline job when the inline job being executed is temporarily stopped.

5. The method according to claim 4, wherein when the inline job executed by said executing is brought to a temporary stop, and if a cause for the temporary stop is not a cause which hinders execution of the offline job, said permitting includes continuing execution of an offline job being currently executed.

6. The method according to claim 5, wherein when the inline job executed by said executing is brought to a temporary stop, and if a cause for the temporary stop is not a cause which hinders execution of the offline job, said permitting includes starting a screen for causing an offline job to be executed.

7. A computer-readable storage medium storing a program for causing a computer to execute a method of controlling a printing system that conveys sheets printed by a printing unit to a sheet processing unit connected to the printing unit and causes the sheet processing unit to perform post processing on the sheet,
wherein the program comprises:
a code to execute either an inline job in which sheets printed by the printing unit are conveyed to the post-processing unit, and post processing is caused to be executed on the sheets by the post-processing unit, or an offline job in which sheets are fed from a predetermined sheet feed section without executing printing by the printing unit, and post processing is caused to be executed on the sheets by the post-processing unit; and
a code to permit execution of an executable offline job when the inline job being executed is temporarily stopped.
